(19) United States
(12) Patent Application Publication
(10) Pub. No.: US 2006/0175277 A1
(43) Pub. Date: Aug. 10, 2006

(54) Lotion bottle with dynamic ornament

(76) Inventor: Hsiao-Liang Ho, Taipei (TW)

Correspondence Address: RABIN & Berdo, PC, 1101 14TH STREET, NW, SUITE 500, WASHINGTON, DC, 20005, US

(21) Appl. No.: 11/111,857

(22) Filed: Apr. 22, 2005

(30) Foreign Application Priority Data
Feb. 5, 2005 (CN) 2005200004155

(51) Int. Cl. B65D 1/04; B05B 11/00; G09F 19/00

(52) U.S. Cl. 215/6; 222/78; 40/406

(57) ABSTRACT

The present invention relates to a lotion bottle comprising dynamic ornament, the lotion bottle comprises a bottle, a bottle top, a nozzle, and a straw, wherein the improvement comprises a dynamic ornamental box, which further comprises at least a dynamic ornament that is driven by a motor, to have a three-dimensional dynamic ornamentation.

### BACKGROUND OF THE INVENTION

1. Field of the Invention

The present invention relates to a lotion bottle with a dynamic ornament, which particularly relates to a bottle comprising an ornament driven by a hidden motor to have a three-dimensional dynamic ornamentation.

2. Description of the Related Art

Lotions bottles are wide used in everyone's daily life. A common lotion bottle is just a container and is disposable when the bottle is empty. This kind of disposable bottles is monotonous for lower cost and is unfriendly to our environment. A proper solution better than recycling junks may be a well-designed reusable lotion bottle.

A proper designed model of the lotion bottle may be the proper solution, and a dynamic design could the best one. Meanwhile, the original structure of a lotion bottle should not be changed to too complex to increase too much cost.

### SUMMARY OF THE INVENTION

The primary object of the present invention is to provide a lotion bottle combining with a proper ornamental object, and a motor driving the ornamental object to a three-dimensional dynamic ornamentation.

Another object of the present invention is to maintain the normal utilization model of the lotion bottle but only to modify the bottle for an ornamental purpose. The lotion bottle of the present invention is reusable by replenishing the bottle with lotion.

For the aforementioned objects, the lotion bottle of the present invention comprises a bottle, a bottle top, a nozzle, a straw, and further a ornamental box comprising at least a dynamic ornament driven by a motor, wherein the ornamental box comprises a transparent cover and a proper designed backdrop casing, the transparent cover covers the backdrop casing and seals. The ornamental box is filled with liquid and loaded with dynamic ornament comprising a magnetic object. The backdrop casing comprises a motor to drive a magnetic bar or a fan comprising magnets by a drive axle thereof. The motor further comprises a waterproof shell to avoid liquid in the ornamental box damaging the motor. The ornamental box is set property fit to the lotion bottle.

The motor of the ornamental box drives the magnetic bar or a fan comprising magnets forming a magnetic field therein that drives the dynamic ornament comprising magnetic object to move in the liquid around the ornamental box. The movement of the dynamic ornament is three-dimensional like swimming, so that the lotion bottle has a dynamic ornamentation.

### BRIEF DESCRIPTION OF THE DRAWINGS

FIG. 1 is a diagram of the perspective view of the first embodiment of the present invention;

FIG. 2 is a diagram of the sectional view of the motor of the first embodiment of the present invention;

FIG. 3 is a diagram of the perspective view of the second embodiment of the present invention;

FIG. 4 is a diagram of the perspective view of the third embodiment of the present invention;

FIG. 5 is a diagram of the sectional view of the motor of the third embodiment of the present invention;

FIG. 6 is a diagram of the perspective view of the fourth embodiment of the present invention.

### DETAILED DESCRIPTION OF THE PREFERRED EMBODIMENTS

In the following description of the embodiments of the present invention, please refer to the drawings.

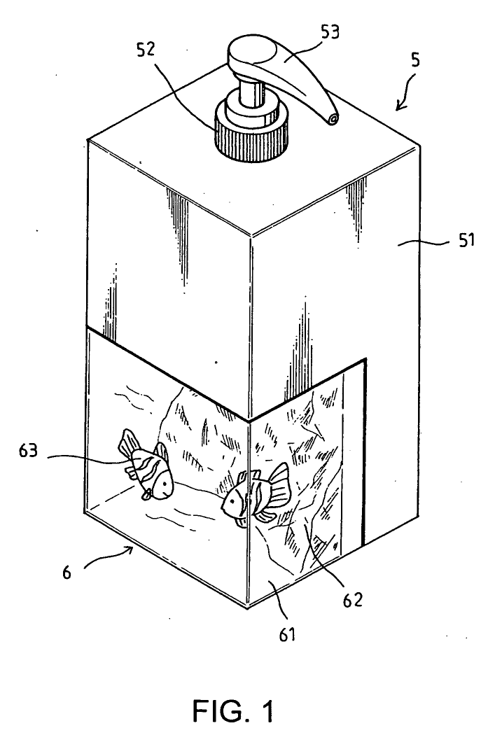

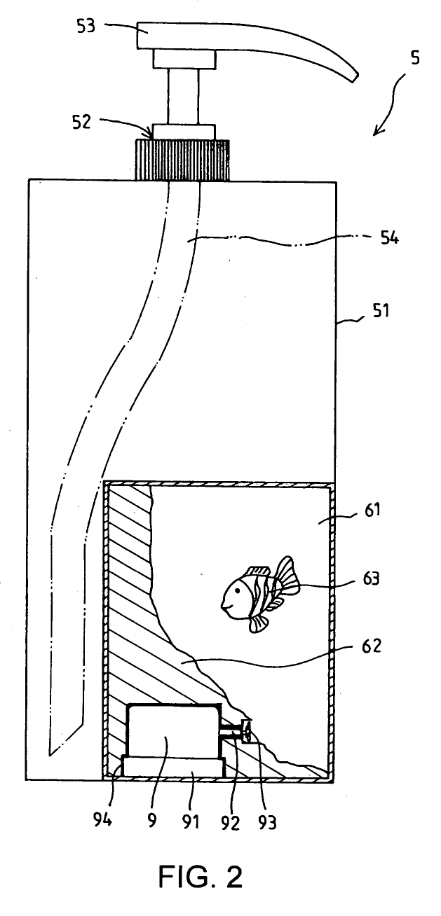

As shown in FIG. 1 and FIG. 2, the first embodiment of the present invention, a lotion bottle 5 of a normal model comprises a bottle 51 and a bottle top 52, a nozzle 53 is installed on the bottle top 52 and a straw 54 connects to the nozzle 53 and is extending to the bottom of the bottle 51 inside as normal. The bottle 51 further comprises a proper shape for an ornamental box 6. With a motor 9 driving the ornamental box 6 is a dynamic ornamentation combined properly with the bottle 51.

The ornamental box 6 comprises a transparent cover 61 and a backdrop casing 62, which can be formed in a proper shape, like a coral reef for example, the transparent cover 61 covers the backdrop casing 62 and seals. The ornamental box 6 is filled with a proper liquid and loaded with at least a proper dynamic ornament 63 comprising magnetic object. A motor 9 is installed behind the backdrop casing 62. The motor 9 comprises a base 91, which can be loaded with battery or connect to outlet as power supply, and a drive axle 92 connected to and driven by the motor 9. The motor 9 further comprises a waterproof shell 94 preventing from water damage.

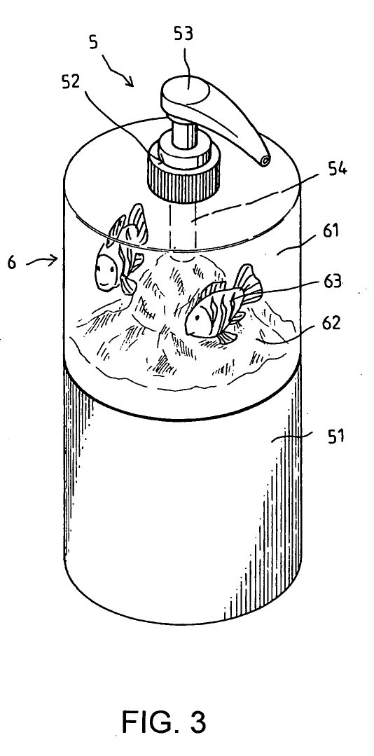

FIGS. 3a, b are diagrams of bottom view of the embodiment of the present invention. The roll holder 1 comprises a plurality of suction cups 5 mounted at the underside of the base 2. The suction cups 5 suck on the surface and the whole roll holder 1 can stand stable and tight fixed on the ground or other smooth surface. An embodiment of the motor 9 is as shown in the FIG. 2. The drive axle 92 of the motor 9 connects to a fan 93 comprising magnets to drive the dynamic ornament 63 comprising magnetic object, a fish model for example, moving around the ornamental box 6, so that the lotion of the present invention presents a live dynamic ornamentation.

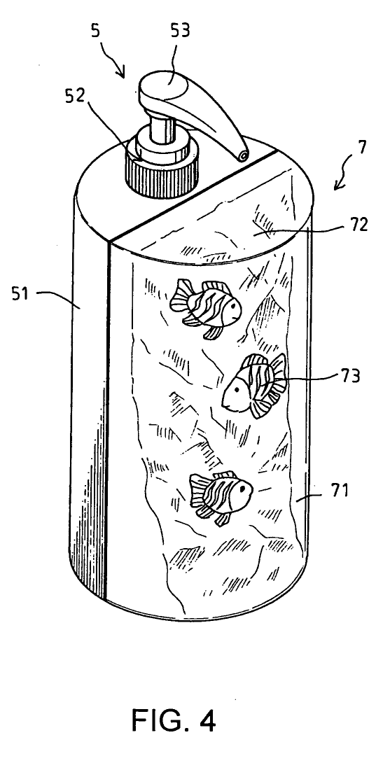

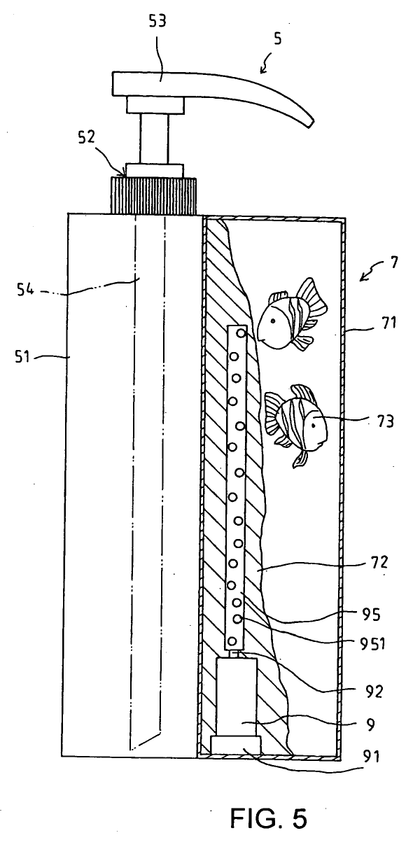

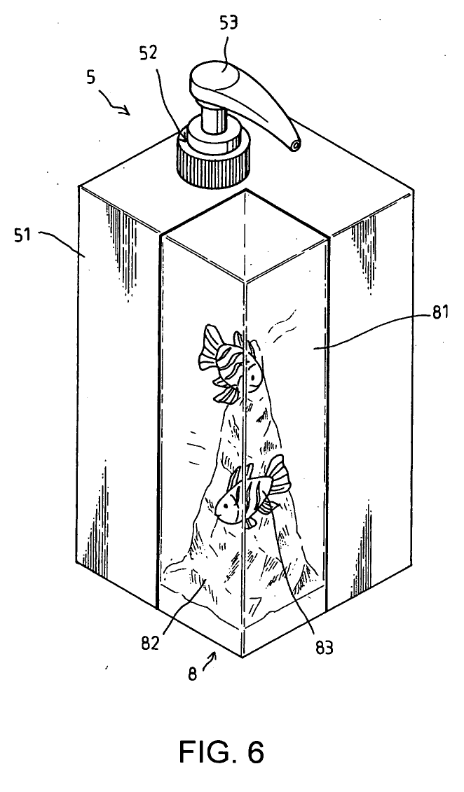

There are many kinds of modification of the preset shape of bottle 51 to fit a proper ornamental box 6. With the motor 9 driving a different designed ornamental box 6 displays different effects. As shown in the FIG. 3, FIG. 4, and FIG. 6, the perspective views of the second, third, and the fourth embodiments of the present invention, there are many kinds of models of the lotion bottles 5 according to different designs of the bottles 51, and can combine with the corresponding ornamental boxes 6, 7, and 8. The dynamic ornaments 63, 73, and 83 of the ornamental box 6 are moving around inside the transparent covers 61, 71, and 81. The motor 9 is set according to the positions and the spaces of the backdrop 62, 72, and 82 of the ornamental boxes 6, 7, and 8. Referring to the FIG. 5, the sectional view of another embodiment of the motor 9, a magnetic bar 95 is connected to the drive axle 92 of the motor 9 and set behind the backdrop 72 forming a magnetic field over the ornamental box 7. The rotation of the magnets 951 of the magnetic bar 95 driven by the motor 9 is changing the magnetic field from time to time, and the dynamic ornament 73 comprising magnetic object in liquid of the ornamental box 7 is moving around and along the magnetic field changing. The moving dynamic ornaments 73 display a live ornamentation, and the ornamental box 7 can be replaced by other kinds of designs, models, or aquarium toys to combine with the bottle 51.

The foregoing describing of the preferred embodiment of the invention is for the purpose of illustration and description. It is not intended to exhaustive or to limit the invention to the precise from disclosed. Many other possible modifications and variations can be made without departing from the scope of the present invention, which following claims are depended.

What is claimed is:

1. A lotion bottle with dynamic ornament comprising a bottle, a bottle top, a nozzle, and a straw, wherein the improvement comprises a dynamic ornamental box, which further comprises at least a dynamic ornament that is driven by a motor.

2. A lotion bottle with dynamic ornament according to the claim 1, wherein the dynamic ornamental box comprises a transparent cover and a proper backdrop casing, the transparent cover covers and seals the backdrop casing.

3. A lotion bottle with dynamic ornament according to the claim 2, wherein the dynamic ornamental box is filled with a proper liquid and loaded with the dynamic ornament.

4. A lotion bottle with dynamic ornament according to the claim 1, wherein the dynamic ornament comprises a proper magnetic object.

5. A lotion bottle with dynamic ornament according to the claim 1, wherein the motor is installed behind the backdrop casing.

6. A lotion bottle with dynamic ornament according to the claim 1, wherein the motor comprises a drive axle, which connects to a magnetic bar.

7. A lotion bottle with dynamic ornament according to the claim 1, wherein the motor comprises a drive axle, which connects to a fan comprising a magnetic structure.

8. A lotion bottle with dynamic ornament according to the claim 1, wherein the motor comprises a waterproof shell.

9. A lotion bottle with dynamic ornament according to the claim 1, wherein the dynamic ornamental box is an ornamental aquarium.

10. A lotion bottle with dynamic ornament according to the claim 3, wherein the dynamic ornament comprises a proper magnetic object.
